(19) United States
(12) Patent Application Publication
(10) Pub. No.: US 2026/0128239 A1
(43) Pub. Date: May 7, 2026

(54) LOW CONTACT RESISTANCE ELECTROMECHANICAL SWITCH

(71) Applicants: TE Connectivity Solutions GmbH, Schaffhausen (CH); AMP Amermex, S.A. de C.V., Chiuahua (MX)

(72) Inventors: Albert Yong Lee, Winston Salem, NC (US); Brian Kuhnly, Winston Salem, NC (US); Abraham Paredes, Winston Salem, NC (US); Roger Lee Thrush, Winston Salem, NC (US); Agustín De la Lanza, Winston Salem, NC (US); Juan C. Romero, Hermosillo, Sonora (MX); Joaquin Antonio Acosta, Hermosillo, Sonora (MX)

(21) Appl. No.: 18/937,226

(22) Filed: Nov. 5, 2024

(51) Int. Cl. H01H 1/06; H01H 1/04; H01H 50/02; H01H 50/54

(52) U.S. Cl. CPC H01H 1/06; H01H 1/04; H01H 50/54; H01H 50/02

(57) ABSTRACT

An electromechanical switch includes a switch housing having a main body forming a chamber with fixed contacts coupled to the switch housing each having a mating end in the chamber and a terminating end exterior of the switch housing. The electromechanical switch includes a movable contact in the chamber movable between an open position and a closed position. The movable contact includes movable mating surfaces configured to be coupled to fixed mating surfaces of the fixed contacts in the closed position and separated from the fixed contacts in the open position. The electromechanical switch includes an actuator with an armature operably coupled to the movable contact. The fixed mating surfaces and/or the movable mating surfaces include textured surface features such that mating interfaces between the fixed contacts and the movable contact each have numerous points of contact.

### BACKGROUND OF THE INVENTION

The subject matter herein relates generally to electromechanical switches.

Certain electrical applications, such as HVAC, power supply, locomotives, elevator control, motor control, aerospace applications, hybrid electric vehicles, fuel-cell vehicles, charging systems, and the like, utilize electromechanical switches, also known as electrical contactors, having contacts that are normally open (or separated). The contacts are closed (or joined) to supply power to a particular device. When the contactor receives an electrical signal, the contactor is energized to introduce a magnetic field to drive a movable contact to mate with fixed contacts. In some instances, contaminants may be deposited on one or more of the mating surfaces of the contacts, which may cause a “no-make” (non-functional) or high resistance situation. The contaminants may block closing of the contacts. The contaminants may be created during assembly, such as being closed into the interior of the contactor when assembled, or may be created over time by degradation of the materials of the housing leading to foreign object debris (FOD) in the interior of the contactor that may settle on the contacts.

### BRIEF DESCRIPTION OF THE INVENTION

In one embodiment, an electromechanical switch is provided and includes a switch housing that has a main body forming a chamber. The electromechanical switch includes fixed contacts coupled to the switch housing. Each fixed contact has a mating end located in the chamber and a terminating end exterior of the switch housing. The fixed contact has a fixed mating surface at the mating end of the corresponding fixed contact. The electromechanical switch includes a movable contact in the chamber and movable between an open position and a closed position. The movable contact includes movable mating surfaces configured to be coupled to the fixed mating surfaces at the mating ends of the fixed contacts in the closed position. The movable contact separated from the fixed contacts in the open position. The electromechanical switch includes an actuator in the chamber. The actuator includes an armature operably coupled to the movable contact to move the movable contact during operation of the actuator. At least one of the fixed mating surfaces and the movable mating surfaces includes textured surface features such that mating interfaces between the fixed contacts and the movable contact each have numerous points of contact.

In another embodiment, an electromechanical switch is provided and includes a switch housing that has a main body forming a chamber. The electromechanical switch includes fixed contacts coupled to the switch housing. Each fixed contact has a mating end located in the chamber and a terminating end exterior of the switch housing. The fixed contact has a fixed mating surface at the mating end of the corresponding fixed contact. The fixed contacts being manufactured from a first metal material has a first material hardness. The electromechanical switch includes a movable contact in the chamber and movable between an open position and a closed position. The movable contact includes movable mating surfaces configured to be coupled to the fixed mating surfaces at the mating ends of the fixed contacts in the closed position. The movable contact separated from the fixed contacts in the open position. The movable contact being manufactured from a second metal material different from the first metal material of the fixed contacts has a second material hardness different from the first material hardness. The electromechanical switch includes an actuator in the chamber. The actuator includes an armature operably coupled to the movable contact to move the movable contact during operation of the actuator.

In a further embodiment, an electromechanical switch is provided and includes a switch housing that has a main body forming a chamber. The electromechanical switch includes fixed contacts coupled to the switch housing. Each fixed contact has a mating end located in the chamber and a terminating end exterior of the switch housing. The fixed contact has a fixed mating surface at the mating end of the corresponding fixed contact. The fixed contacts being manufactured from a first metal material has a first material hardness. The electromechanical switch includes a movable contact in the chamber and movable between an open position and a closed position. The movable contact includes movable mating surfaces configured to be coupled to the fixed mating surfaces at the mating ends of the fixed contacts in the closed position. The movable contact separated from the fixed contacts in the open position. The movable contact being manufactured from a second metal material different from the first metal material of the fixed contacts has a second material hardness different from the first material hardness. The electromechanical switch includes an actuator in the chamber. The actuator includes an armature operably coupled to the movable contact to move the movable contact during operation of the actuator. At least one of the fixed mating surfaces and the movable mating surfaces includes textured surface features such that mating interfaces between the fixed contacts and the movable contact each have numerous points of contact.

### BRIEF DESCRIPTION OF THE DRAWINGS

FIG. 1 illustrates an electromechanical switch in accordance with an exemplary embodiment.

FIG. 2 is a sectional view of the electromechanical switch in accordance with an exemplary embodiment illustrating internal components of the electromechanical switch.

FIG. 3 illustrates the fixed contact in accordance with an exemplary embodiment.

FIG. 4 illustrates the movable contact in accordance with an exemplary embodiment.

FIG. 5 illustrates a portion of the movable contact in accordance with an exemplary embodiment.

FIG. 6 illustrates a portion of the electromechanical switch showing the movable contact in an open position in accordance with an exemplary embodiment.

FIG. 7 illustrates a portion of the electromechanical switch showing the movable contact in a closed position in accordance with an exemplary embodiment.

FIG. 8 illustrates a portion of the electromechanical switch showing contaminants on the movable contact in accordance with an exemplary embodiment.

FIG. 9 is a cross-sectional view of a portion of the electromechanical switch in a closed position in accordance with an exemplary embodiment.

### DETAILED DESCRIPTION OF THE INVENTION

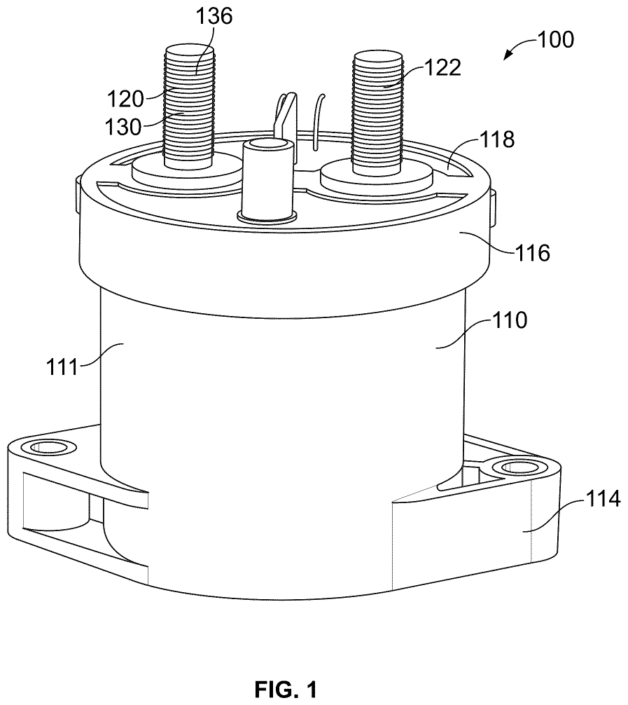

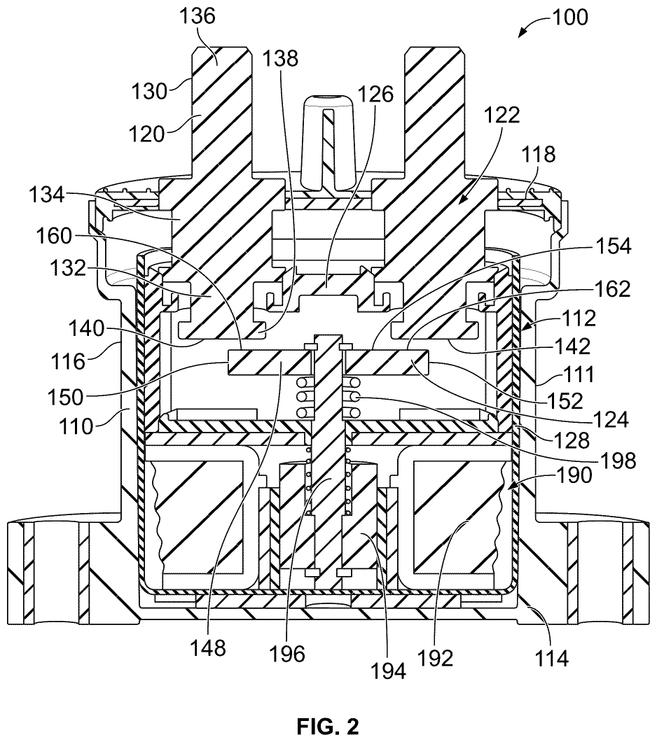

FIG. 1 illustrates an electromechanical switch 100 in accordance with an exemplary embodiment. FIG. 2 is a sectional view of the electromechanical switch 100 in accordance with an exemplary embodiment illustrating internal components of the electromechanical switch 100. The electromechanical switch 100 may be a switch or relay that safely connects and disconnects one or more electrical circuits to protect the flow of power through the system. The electromechanical switch 100 may be used in various applications such as HVAC, power supply, locomotives, elevator control, motor control, aerospace applications, hybrid electric vehicles, fuel-cell vehicles, charging systems, and the like.

The electromechanical switch 100 includes a housing 110 (removed in FIG. 2 to illustrate the internal components of the electromechanical switch 100) having an outer wall 111 surrounding a chamber 112. The housing 110 may be a multi-piece housing in various embodiments. The housing 110 includes a base 114 and a header 116 extending from the base 114. Optionally, the base 114 may be configured to be coupled to another component. For example, the base 114 may include mounting brackets for securing the electromechanical switch 100 to the other component. In the illustrated embodiment, the base 114 is provided at a bottom of the electromechanical switch 100 and the header 116 is located above the base 114; however, the housing 110 may have other orientations in alternative embodiments. The housing 110 includes a cover 118 (FIG. 1) for closing the chamber 112. For example, the cover 118 may be coupled to the top of the header 116. Optionally, the cover 118 may be sealed to the header 116. The outer wall 111 along the header 116 may be cylindrical defining a cylindrical chamber 112 in various embodiments. The chamber 112 may be at least partially filled with epoxy for sealing the housing 110 and internal components.

The electromechanical switch 100 includes first and second fixed contacts 120, 122 received in the chamber 112 and a movable contact 124 movable within the chamber 112 between a closed or mated position and an open or unmated position. The movable contact 124 electrically connects the fixed contacts 120, 122 in the closed/mated position. The fixed contacts 120, 122 are fixed to the housing 110. For example, the fixed contacts 120, 122 may be coupled to the header 116 and/or the cover 118. In an exemplary embodiment, a contact holder 126 is used to hold the fixed contacts 120, 122. The contact holder 126 is received in the chamber 112 and coupled to the housing 110. The contact holder 126 may be removable from the chamber 112 when the cover 118 is removed from the header 116. The contact holder 126 defines an enclosure 128. The fixed contacts 120, 122 extend into the enclosure 128. The movable contact 124 is located in the enclosure 128. The outer wall 111 surrounds the enclosure 128.

The fixed contacts 120, 122 each include an outer end defining a terminating end 130 and an inner end defining a mating end 132. The fixed contacts 120, 122 each have a transition portion 134 between the ends that transitions between the interior and exterior of the chamber 112. In the illustrated embodiment, the fixed contacts 120, 122 are generally cylindrical, such as including one or more cylindrical segments. The terminating end 130 and the mating end 132 may extend along a common longitudinal axis of the fixed contact 120, 122. Other shapes are possible in alternative embodiments.

The terminating end 130 is configured to be terminated to another component, such as a wire or a terminal, such as a line in or a line out wire. In an exemplary embodiment, the terminating end 130 is exposed at the exterior of the electromechanical switch 100 for terminating to the other component. The terminating end 130 may be threaded to receive a nut. For example, the terminating end 130 may include a threaded post 136. In the illustrated embodiment, the terminating end 130 extends through the cover 118 and is located above the cover 118. However, the terminating end 130 may have other features for terminating to the cable or a busbar, such as a weld pad.

The mating end 132 is located within the chamber 112 for connection with the movable contact 124, such as when the electromechanical switch 100 is energized. In an exemplary embodiment, the mating end 132 includes a mating post 138 having a mating pad at the distal end of the fixed contact 120, 122. The mating pad may be oriented generally horizontally. The first and second fixed contact 120, 122 include first and second fixed mating surfaces 140, 142, respectively, at the mating ends 132 thereof. The movable contact 124 is configured to be coupled to the fixed contact 120, 122 at the fixed mating surfaces 140, 142. The fixed mating surfaces 140, 142 of the fixed contacts 120, 122 may be coplanar with each other for mating with the movable contact 124.

The movable contact 124 includes a contact body 148 extending between a first end 150 and a second end 152. The first and second ends 150, 152 are configured to be mated to the first and second fixed contacts 120, 122. The contact body 148 has a central portion 154 between the first and second ends 150, 152. The movable contact 124 includes first and second movable mating surfaces 160, 162 at the first and second ends 150, 152. The first and second movable mating surfaces 160, 162 are configured to be coupled to the first and second fixed mating surfaces 140, 142 in the closed position.

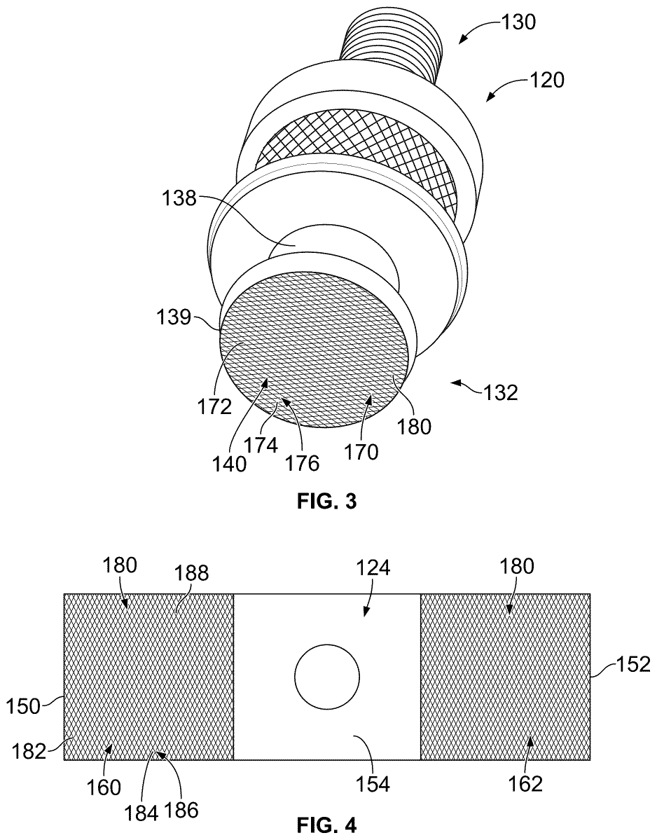

In an exemplary embodiment, the fixed mating surfaces 140, 142 and/or the movable mating surfaces 160, 162 include textured surface features (examples shown in FIGS. 3-5) to form mating interfaces between the fixed contacts 120, 122 and the movable contact 124 having numerous points of contact. The textured surface features include surface roughened features, such as protrusions, projections, cuts, grooves, peaks, valleys, or other features to roughen, texturize or otherwise make the surface uneven. The textured surface features form non-planar mating interfaces. For example, the textured surface features include protrusions forming peaks defining the points of contact and grooves between the peaks. The grooves form spaces to receive any contaminants (for example, plastic particles) and locate the contaminants away from the peaks. The peaks protrude beyond (for example, stand proud of) the contaminants to ensure direct metal-to-metal contact at the points of contact for a low resistance, high current interface between the movable contact 124 and the fixed contacts 120, 122. In various embodiments, the textured surface features include knurls formed by a knurling process. The textured surface features may be diamond shaped. However, the textured surface features may have other shapes. The textured surface features have a height taller than the average particle size. For example, for particle sizes of approximately 40 microns, the textured surface features may have a height of at least 100 microns.

In an exemplary embodiment, the fixed contacts 120, 122 include the textured surface features and the movable contact 124 is devoid of the textured surface features. For example, the movable contact 124 has planar surfaces at the movable mating surfaces 160, 162. In another exemplary embodiment, the movable contact 124 includes the textured surface features and the fixed contacts 120, 122 are devoid of the textured surface features. For example, the fixed contacts 120, 122 may be planar at the fixed mating surfaces 140, 142. In another exemplary embodiment, the movable contact 124 includes the textured surface features at the movable mating surfaces 160, 162 and the fixed contacts 120, 122 include the textured surface features at the fixed mating surfaces 140, 142.

In an exemplary embodiment, the fixed contacts 120, 122 are manufactured from a first metal material and the movable contact 124 is manufactured from a second metal material different from the first metal material. The fixed contacts 120, 122 are manufactured from a material having a first material hardness and the movable contact 124 is manufactured from a material having a second material hardness different from the first material hardness. In an exemplary embodiment, the first material hardness is harder than the second material hardness.

In an exemplary embodiment, the first metal material is a copper (or copper alloy) material and the second metal material is a different copper (or copper alloy) material. For example, the first metal material may be a harder copper material and the second metal material may be a softer copper material. The softer copper material provides a lower resistance at the mating interface than the harder copper material. The softer copper material may be more malleable or ductile at the mating interface to conform to the shape of the harder copper material for enhanced mating (for example, to increase contact area and thus lower contact resistance). The first metal material may be hard copper and the second metal material may be soft copper. In various embodiments, the first metal material may be one of H04 copper, H03 copper, H02 copper, H01 copper, or H00 copper that is harder than the second metal material. The second metal material may be one of H03 copper, H02 copper, H01 copper, H00 copper, or soft copper that is softer than the first metal material. The first metal material may be a tempered copper material and the second metal material is a tempered copper material. The first metal material may be more tempered than the second metal material forming a harder copper material than the second metal material.

The electromechanical switch 100 includes a coil assembly 190 in the chamber 112 operated to move the movable contact 124 between the unmated position and the mated position. The coil assembly 190 includes a winding or coil 192 wound around a magnetic core 194 to form an electromagnetic field. The coil assembly 190 includes an armature 196 coupled to the core 194. The movable contact 124 is coupled to the armature 196 and is movable with the armature 196 when the coil assembly 190 is operated. The armature 196 may be a plunger movable in a vertical direction. The coil assembly 190 includes a spring 198 for returning the movable contact 124 to the unmated position when the coil assembly 190 is deenergized. Optionally, the electromechanical switch 100 may include an arc suppressor (not shown) for suppressing electrical arc of the electrical circuit. The arc suppressor may be located in the chamber 112 of the housing 110. In an exemplary embodiment, the contact holder 126 may be sealed, such as using epoxy, and may be filled with an inert gas for arc suppression.

FIG. 3 illustrates the fixed contact 120 in accordance with an exemplary embodiment. The fixed contact 120 includes the terminating end 130 and the mating end 132. In an exemplary embodiment, the fixed contact 120 includes textured surface features 170 at the mating end 132, such as at the fixed mating surface 140.

The mating end 132 includes a mating post 138 having a mating pad 139 at the distal end of the fixed contact 120. The mating pad 139 includes the fixed mating surface 140. The textured surface features 170 are provided at the mating pad 139. The textured surface features 170 may substantially or entirely cover the mating pad 139. The textured surface features 170 form mating interfaces for mating with the movable contact 124 (shown in FIG. 2). The textured surface features 170 define numerous points of contact at the fixed mating surface 140. In an exemplary embodiment, the textured surface features 170 form non-planar mating interfaces.

In an exemplary embodiment, the textured surface features 170 include protrusions 172 forming peaks 174 defining the points of contact and grooves 176 between the peaks 174. The grooves 176 form spaces to receive any contaminants (for example, plastic particles) and locate the contaminants away from the peaks. The peaks 174 protrude beyond (for example, stand proud of) the contaminants to ensure direct metal-to-metal contact at the points of contact for a low resistance, high current interface between the movable contact 124 and the fixed contact 120.

In an exemplary embodiment, the textured surface features 170 include knurls 178 formed by a knurling process. The textured surface features 170 may be diamond shaped. However, the textured surface features 170 may have other shapes. The textured surface features 170 have a height taller than the average particle size.

FIG. 4 illustrates the movable contact 124 in accordance with an exemplary embodiment. The movable contact 124 includes the first and second mating ends 150, 152 configured to be mated with the first and second fixed contacts 120, 122 (shown in FIG. 2), respectively. The movable contact 124 includes the movable mating surfaces 160, 162 at the first and second mating ends 150, 152.

In an exemplary embodiment, the movable contact 124 includes textured surface features 180 at the first and second mating ends 150, 152, such as at the movable mating surfaces 160, 162. The textured surface features 180 may substantially or entirely cover the mating ends 150, 152. The textured surface features 180 may substantially or entirely cover the central portion 154 between the mating ends 150, 152. The textured surface features 180 form mating interfaces for mating with the fixed contacts 120, 122. The textured surface features 180 define numerous points of contact at the movable mating surfaces 160, 162. In an exemplary embodiment, the textured surface features 180 form non-planar mating interfaces.

In an exemplary embodiment, the textured surface features 180 include protrusions 182 forming peaks 184 defining the points of contact and grooves 186 between the peaks 184. The grooves 186 form spaces to receive any contaminants (for example, plastic particles) and locate the contaminants away from the peaks. The peaks 184 protrude beyond (for example, stand proud of) the contaminants to ensure direct metal-to-metal contact at the points of contact for a low resistance, high current interface between the movable contact 124 and the fixed contacts 120, 122.

In an exemplary embodiment, the textured surface features 180 include knurls 188 formed by a knurling process. The textured surface features 180 may be diamond shaped. However, the textured surface features 180 may have other shapes. The textured surface features 180 have a height taller than the average particle size.

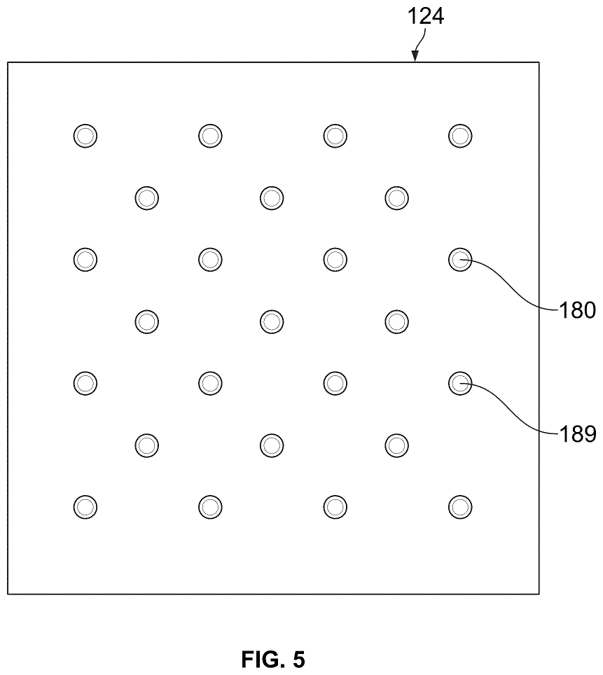

FIG. 5 illustrates a portion of the movable contact 124 in accordance with an exemplary embodiment. The movable contact 124 includes the textured surface features 180. In the illustrated embodiment, the textured surface features 180 include bumps 189 formed on the surface rather than including the knurls 188 (shown in FIG. 4). The bumps 189 form mating interfaces for mating with the fixed contact 120, 122.

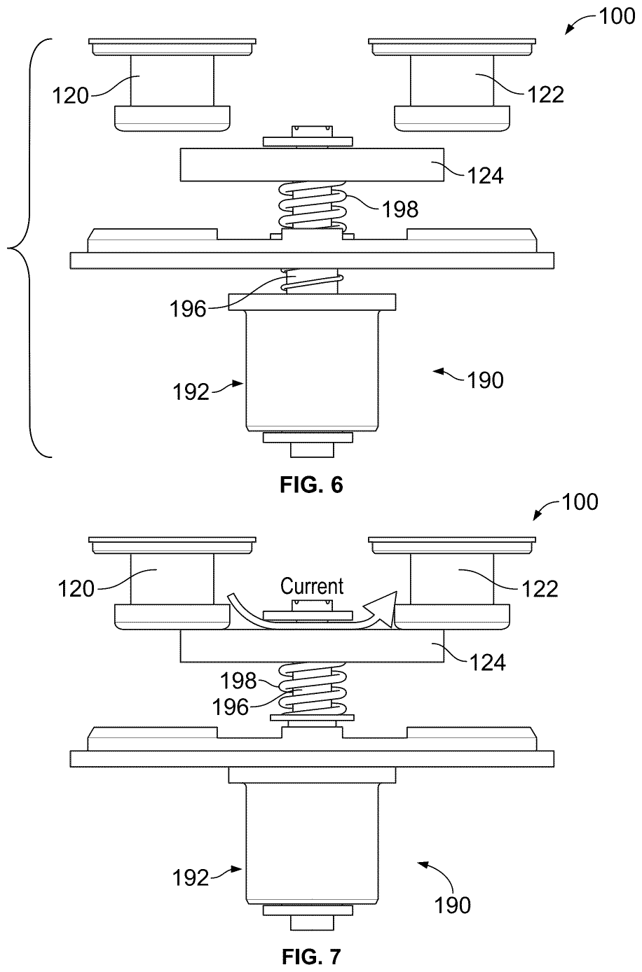

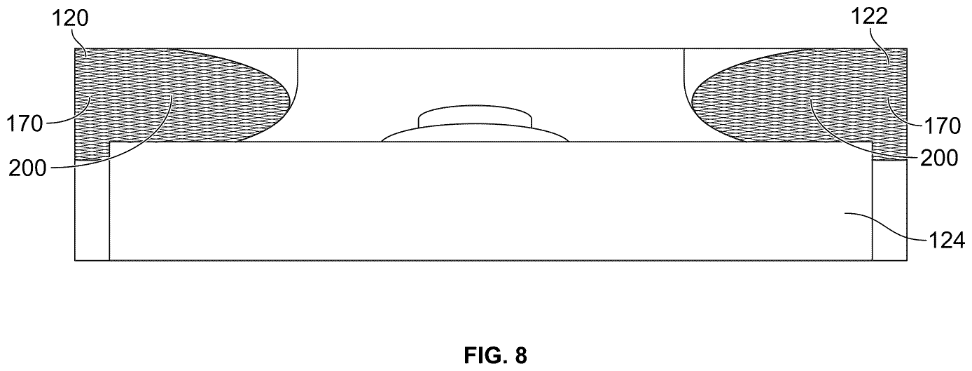

FIG. 6 illustrates a portion of the electromechanical switch 100 showing the movable contact in an open position. FIG. 7 illustrates a portion of the electromechanical switch 100 showing the movable contact in a closed position. FIG. 8 illustrates a portion of the electromechanical switch 100 showing contaminants 200 (for example, a plastic particle) on the movable contact.

The movable contact 124 is movable between the open position and the closed position by activating the coil assembly 190. For example, the coil 192 is energized to form an electromagnetic around a magnetic core 194, which drives the armature 196 in an activation direction (for example, upward). The armature 196 drives the movable contact 124 to the closed position. When the coil 192 is deenergized, the return spring 198 returns the movable contact 124 and the armature 196 to the unmated/open position. As shown in FIG. 8, when contaminants 200 are created in the chamber, the contaminants 200 may contaminate the surfaces of the fixed contacts 120, 122 and/or the movable contact 124. The textured surface features (for example, the textured surface features 170, 180 shown in FIGS. 3-5) may accommodate the contaminants 200 by providing points of contact that protrude beyond the contaminants 200 allowing direct metal-to-metal contact between the movable contact 124 and the fixed contacts 120, 122 even in the presence of the contaminants 200.

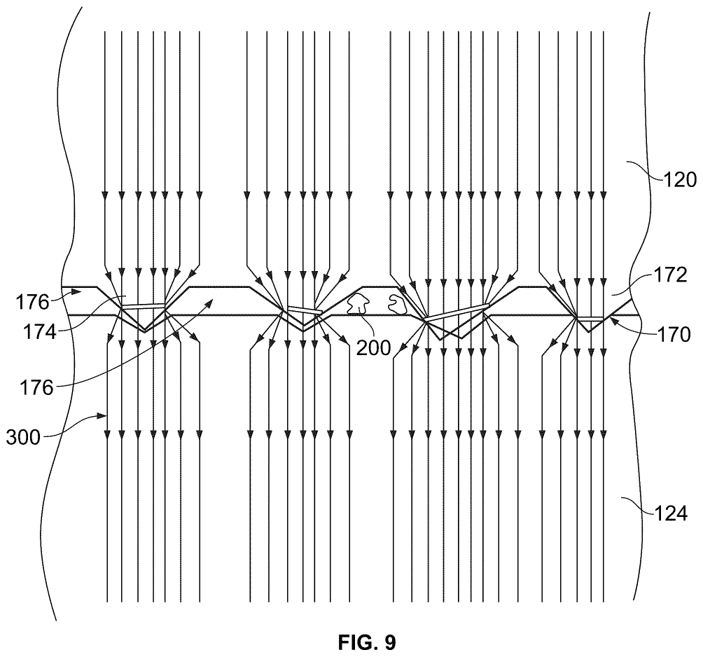

FIG. 9 is a cross-sectional view of a portion of the electromechanical switch 100 in a closed position. FIG. 9 shows the direct metal-to-metal contact between the movable contact 124 and the fixed contact 120, even in the presence of the contaminants 200.

In the illustrated embodiment, the fixed contact 120 includes the textured surface features 170 forming points of contact with the movable contact 124. The textured surface features 170 include the protrusions 172 forming the peaks 174 and the grooves 176 between the peaks 174. The grooves 176 form spaces to receive any contaminants 200 (for example, plastic particles). The peaks 174 protrude beyond (for example, stand proud of) the contaminants 200 to ensure direct metal-to-metal contact at the points of contact for a low resistance, high current interface between the movable contact 124 and the fixed contact 120. Current flow lines 300 are shown in FIG. 9 to illustrate the flow of the current through the textured surface features 170.

In an exemplary embodiment, the movable contact 124 is manufactured from a metal material that is softer than the fixed contact 120. For example, the movable contact 124 may be soft copper and the fixed contact 120 may be hard copper. The metal material of the movable contact 124 has lower resistance than the metal material of the fixed contact 120 to allow more current to flow through the interface (for example, compared to an embodiment using contacts both manufactured from hard copper). The metal material of the movable contact 124 may partially deform during mating to conform to the shape of the fixed contact 120, which may increase the amount of surface area in direct contact at the mating interface, which lowers resistance to allow more current to flow through the interface (for example, compared to an embodiment using contacts both manufactured from hard copper).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. An electromechanical switch comprising:
a switch housing having a main body forming a chamber;
fixed contacts coupled to the switch housing, each fixed contact having a mating end located in the chamber and a terminating end exterior of the switch housing, the fixed contact having a fixed mating surface at the mating end of the corresponding fixed contact;
a movable contact in the chamber and movable between an open position and a closed position, the movable contact including movable mating surfaces configured to be coupled to the fixed mating surfaces at the mating ends of the fixed contacts in the closed position, the movable contact separated from the fixed contacts in the open position; and
an actuator in the chamber, the actuator including an armature operably coupled to the movable contact to move the movable contact during operation of the actuator;
wherein at least one of the fixed mating surfaces and the movable mating surfaces includes textured surface features such that mating interfaces between the fixed contacts and the movable contact each have numerous points of contact.

2. The electromechanical switch of claim 1, wherein the at least one of the fixed mating surfaces and the movable mating surfaces including the textured surface features is non-planar.

3. The electromechanical switch of claim 1, wherein the textured surface features include knurls.

4. The electromechanical switch of claim 1, wherein the textured surface features include protrusions forming peaks defining the points of contact and grooves between the peaks.

5. The electromechanical switch of claim 1, wherein the textured surface features are diamond shaped.

6. The electromechanical switch of claim 1, wherein the textured surface features have a height of at least 100 microns.

7. The electromechanical switch of claim 1, wherein the fixed contacts include the textured surface features and the movable contact is devoid of the textured surface features being planar at the movable mating surface.

8. The electromechanical switch of claim 1, wherein the movable contact includes the textured surface features and the fixed contacts are devoid of the textured surface features being planar at the fixed mating surface.

9. The electromechanical switch of claim 1, wherein the fixed contacts are manufactured from a first metal material having a first material hardness and the movable contact is manufactured from a second metal material different from the first metal material having a second material hardness different from the first material hardness.

10. The electromechanical switch of claim 9, wherein the first material hardness is harder than the second material hardness.

11. The electromechanical switch of claim 9, wherein the first metal material is hard copper in the second metal material is soft copper.

12. The electromechanical switch of claim 9, wherein the first metal material is one of H04 copper, H03 copper, H02 copper, H01 copper, or H00 copper and wherein the second metal material is one of H03 copper, H02 copper, H01 copper, H00 copper, or soft copper.

13. The electromechanical switch of claim 9, wherein the first metal material is a tempered copper material and the second metal material is a tempered copper material, wherein the first metal material is more tempered than the second metal material.

14. An electromechanical switch comprising:
a switch housing having a main body forming a chamber;
fixed contacts coupled to the switch housing, each fixed contact having a mating end located in the chamber and a terminating end exterior of the switch housing, the fixed contact having a fixed mating surface at the mating end of the corresponding fixed contact, the fixed contacts being manufactured from a first metal material having a first material hardness;
a movable contact in the chamber and movable between an open position and a closed position, the movable contact including movable mating surfaces configured to be coupled to the fixed mating surfaces at the mating ends of the fixed contacts in the closed position, the movable contact separated from the fixed contacts in the open position, the movable contact being manufactured from a second metal material different from the first metal material of the fixed contacts having a second material hardness different from the first material hardness; and
an actuator in the chamber, the actuator including an armature operably coupled to the movable contact to move the movable contact during operation of the actuator.

15. The electromechanical switch of claim 14, wherein the first material hardness is harder than the second material hardness.

16. The electromechanical switch of claim 14, wherein the first metal material is hard copper in the second metal material is soft copper.

17. The electromechanical switch of claim 14, wherein the first metal material is one of H04 copper, H03 copper, H02 copper, H01 copper, or H00 copper and wherein the second metal material is one of H03 copper, H02 copper, H01 copper, H00 copper, or soft copper.

18. The electromechanical switch of claim 14, wherein the first metal material is a tempered copper material and the second metal material is a tempered copper material, wherein the first metal material is more tempered than the second metal material.

19. The electromechanical switch of claim 14, wherein at least one of the fixed mating surfaces and the movable mating surfaces includes textured surface features such that mating interfaces between the fixed contacts and the movable contact each have numerous points of contact.

20. An electromechanical switch comprising:
a switch housing having a main body forming a chamber;
fixed contacts coupled to the switch housing, each fixed contact having a mating end located in the chamber and a terminating end exterior of the switch housing, the fixed contact having a fixed mating surface at the mating end of the corresponding fixed contact, the fixed contacts being manufactured from a first metal material having a first material hardness;
a movable contact in the chamber and movable between an open position and a closed position, the movable contact including movable mating surfaces configured to be coupled to the fixed mating surfaces at the mating ends of the fixed contacts in the closed position, the movable contact separated from the fixed contacts in the open position, the movable contact being manufactured from a second metal material different from the first metal material of the fixed contacts having a second material hardness different from the first material hardness; and
an actuator in the chamber, the actuator including an armature operably coupled to the movable contact to move the movable contact during operation of the actuator;
wherein at least one of the fixed mating surfaces and the movable mating surfaces includes textured surface features such that mating interfaces between the fixed contacts and the movable contact each have numerous points of contact.
